(19) United States
(12) Patent Application Publication
(10) Pub. No.: US 2023/0313523 A1
(43) Pub. Date: Oct. 5, 2023

(54) MODULAR FACTORY BUILDING

(71) Applicant: SHANGHAI MORIMATSU PHARMACEUTICAL EQUIPMENT ENGINEERING CO., LTD., Shanghai (CN)

(72) Inventors: Zhenfei Huo, Shanghai (CN); Wei Yan, Shanghai (CN); Yongzhu Jin, Shanghai (CN); Mingdi Du, Shanghai (CN); Wenyan Li, Shanghai (CN); Daoquan Li, Shanghai (CN); Xiaodi You, Shanghai (CN)

(21) Appl. No.: 17/794,091

(22) PCT Filed: Dec. 3, 2020
(86) PCT No.: PCT/CN2020/133527

§ 371 Date: Jul. 20, 2022

(30) Foreign Application Priority Data
May 11, 2020 (CN) 202010393576.4

(51) Int. Cl. E04B 1/348; F24F 13/02; F16L 3/26

(52) U.S. Cl. CPC E04B 1/34869; E04B 1/3483; F24F 13/0209; F16L 3/26; E04B 2001/2415

(57) ABSTRACT

A modular factory building, comprising a plurality of modules (10), the module (10) including a framework (11) provided with an apparatus installation area for installing process equipment (13) and/or utility equipment (14), an air duct system, a pipe system and a cable tray system, wherein the air duct system, the pipe system and the cable tray system are arranged on the framework (11) and are connected with the process equipment (13) and/or the utility equipment (14). The afore-described modular factory building is capable of improving the construction efficiency, reducing the construction period, and saving the construction cost.

### TECHNICAL FIELD

The present disclosure relates to the field of building construction, and in particular to a modular factory building.

### BACKGROUND

In general, the traditional industrial buildings are built by reinforced concrete frame construction. Moreover, the industrial building includes a variety of functional areas such as air duct system installation, piping system installation, mechanical system installation and electrical system installation. The traditional construction method is reinforced concrete construction, which is time-consuming and laborious, and there are technical problems of low efficiency as well as long period of construction.

### SUMMARY

The present disclosure intends to propose a modular factory building which can improve the construction efficiency and reducing the construction period.

For this purpose, the present disclosure proposes the following technical solution:

A modular factory building comprises a plurality of modules, the module including a framework provided with an apparatus installation area for installing a process equipment and/or a utility equipment, an air duct system, pipe system, and cable tray system, all above mentioned systems are arranged on the framework and should be connected with the process equipment and/or the utility equipment.

In one of the embodiments, the modular factory building further comprises a top plate arranged on a top of the framework and a side plate installed on a side of the framework.

In one of the embodiments, the modular factory building further comprises a connection part through which frameworks of the two adjacent modules are connected.

In one of the embodiments, the connection part includes a fastener and a connection plate arranged between the two adjacent frameworks, wherein the connection plate is respectively connected with the two frameworks by the fastener.

In one of the embodiments, the fastener is a bolt.

In one of the embodiments, the module further comprises a square air duct connection part, through which square air ducts in the air duct systems of the two adjacent modules are connected, wherein the square air duct connection part includes a square connecting duct and an air duct connecting flange, and the square connecting duct is respectively connected with the corresponding square air duct by the air duct connecting flange.

In one of the embodiments, the module further comprises a circular air duct connection part, through which circular air ducts in the air duct systems of the two adjacent modules are connected, wherein the circular air duct connection part includes a circular connecting duct which is in insertion connection with the corresponding circular air duct.

In one of the embodiments, the circular air duct connection part further comprises a clamp, which is connected with the circular connecting duct.

In one of the embodiments, the module further comprises a pipe connecting flange, through which the pipes in the pipe systems of the two adjacent modules are connected.

In one of the embodiments, the module further comprises a cable tray connection part, through which cable tray in the cable tray systems of the two adjacent modules are connected, wherein the cable tray connection part includes a tray connecting plate and fasteners, and the tray connecting plate is respectively connected with the corresponding cable tray by the fasteners.

The afore-described modular factory building comprises a plurality of modules. The air duct system, the pipe system and the cable tray system are integrated in the module. The framework is provided with an apparatus installation area for installing process equipment and/or utility equipment. Further, the integration of the air duct system, the pipe system, the cable tray system (i.e., electric functional area) and the apparatus installation area can be completed within the manufacturing workshop. On the construction site, there is only necessary to assemble the plurality of modules, involving simple and convenient operation which makes it possible to achieve high construction efficiency and effectively reduce the construction period. In addition, the integration process of the module may be carried out simultaneously with the construction of the on-site fundamental auxiliary projects, which further saves the construction period of the entire project.

### BRIEF DESCRIPTION OF THE DRAWINGS

FIG. 1 is a partial structural exploded diagram of modular factory building according to an embodiment.

FIG. 2 is a detail drawing of framework connection when modules according to an embodiment.

FIG. 3 is a detail drawing of air duct connection when modules according to an embodiment.

FIG. 4 is a detail drawing of cable tray connection when modules according to an embodiment.

### REFERENCE SIGNS

10—module, 11—framework, 13—process equipment, 14—utility equipment, 15—square air duct, 16—circular air duct, 17—pipe, 18—cable tray, 20—connection part, 21—connection plate, 22—fastener, 30—square air duct connection part, 31—square connecting duct, 32—air duct connecting flange, 40—circular air duct connection part, 41—circular connecting duct, 42—clamp, 50—pipe connecting flange, 60—cable tray connection part, 61—tray connection plate.

### DETAILED DESCRIPTION

With reference to the attached drawings and specific embodiments, the technical solution of the present disclosure is further explained subsequently.

In the description of the present disclosure, it is appreciated that a directional or positional relationship indicated by the terms “upper” “lower”, “front”, “rear”, “left”, “right”, “vertical”, “horizontal”, “top”, “bottom”, “inner”, “outer”, and the like is the directional or positional relationship shown by the drawings. The above terms are used in order to facilitate and simplify the description of the present disclosure, not to indicate or imply that the referred device or element must have a particular orientation, be constructed and operate in a particular orientation, and therefore are not to be construed as a limitation to the present disclosure.

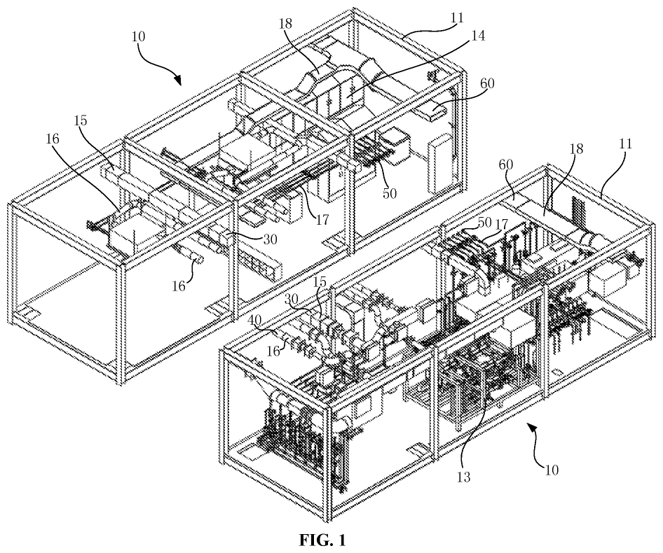

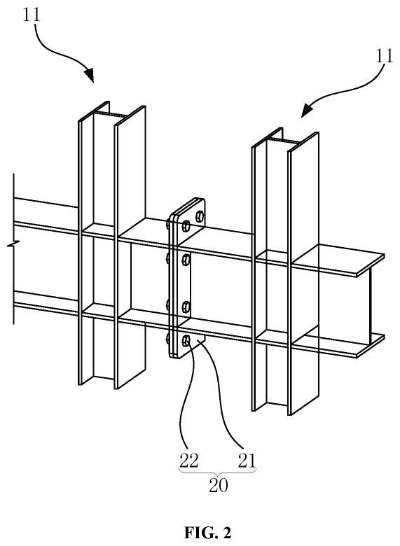

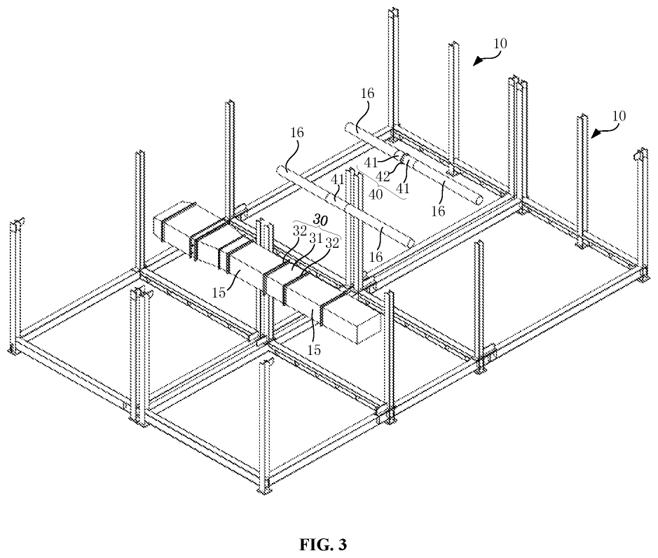

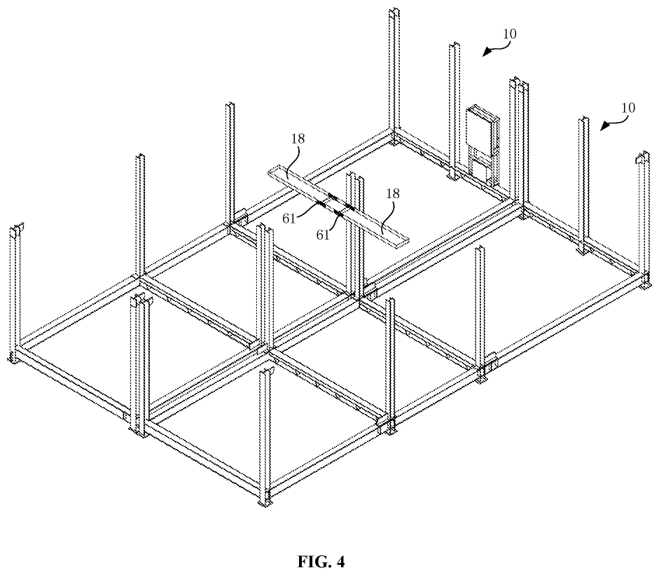

Referring to FIGS. 1 to 4, the modular factory building according to an embodiment comprises a plurality of modules 10. The module 10 comprises a framework 11 provided with an apparatus installation area for installing a process equipment 13 and/or a utility equipment 14, an air duct system, a pipe system, and a cable tray system. Each of the air duct system, the pipe system, and the cable tray system is arranged on the framework 11 and is connected with the process equipment 13 and/or the utility equipment 14.

Specifically, the framework 11 is adopted by steel structure. The apparatus installation area may be a steel plate or a steel beam arranged on the framework 11, or a combined structure of a steel plate and a steel beam, or even a reinforced concrete floor slab structure, which is not limited hereto. The air duct system, the pipe system, and the cable tray system are installed on an upper area of the framework 11. Further, the cable tray system is arranged within a space that is 300 mm to 600 mm below the upper beam of the framework 11, and the air duct system is arranged above the cable tray system. In addition, not only the process equipment 13 but also the utility equipment 14 including a power supply apparatus, a ventilation device, a cooling apparatus, a fire fighting kit, and the like may be installed on the apparatus installation area. As shown in FIG. 1, among the two modules 10, the process equipment 13 is located in the apparatus installation area of one module 10 on which the pipe system is connected with the process equipment 13. The utility equipment 14 is located in the apparatus installation area of the other module 10 on which the air duct system and the cable tray system are respectively connected with the utility equipment. In other embodiments, the process equipment 13 and utility equipment 14 may be located on the same module 10, which is not limited hereto.

The afore-described modular factory building comprises a plurality of modules 10. The module 10 integrates therein an air duct system, a pipe system, and a cable tray system. The framework 11 is provided with the process equipment 13 and/or the utility equipment 14. The integration of the air duct system, the pipe system, the cable tray system (i.e., electric functional area), and the apparatus installation area may be constructed in the manufacturing workshop. On the construction site, there is only necessary to assemble the plurality of modules 10 to complete the on-site assembly work between the modules 10, involving simple and convenient operation which makes it possible to achieve high construction efficiency and effectively reduce the construction period. In addition, the integration process of the module 10 may be carried out simultaneously with the construction of the on-site fundamental auxiliary projects, which further saves the construction period of the entire project.

In an embodiment, the modular factory building further comprises a top plate and a side plate (both not shown). The top plate is arranged on a top of the framework 11. The side plate is installed on a side of the framework 11. Specifically, the number of the side plate and the installation position of the side plate on the framework 11 are provided according to the installation position of the module 10 during assembly on site. In this embodiment, the top plate and the side plate are mounted on the framework 11 so that on the one hand the top plate and side plate protects apparatuses and pipelines inside the framework 11, and on the other hand the top plate and the side plate can form a seal when the assembly of module 10 is completed, thereby enabling the modular factory building to satisfy both indoor and outdoor use requirements.

More specifically, the top plate and the side plate of the modular factory building for applications in different scenarios adopt different kinds of panel materials. For example, when the exterior wall panel were used in mechanical area of modular factory building, the side plate comprises a profiled steel sheet with a thickness of 0.5 mm, a waterproof vapor barrier layer, a thermal insulation layer, light steel studs and a cement slab, arranged in that order. The cement slab serves as a temporary rainproof exterior wall, and the profiled steel sheet serves as a decorative layer. When the fire rated wall panel were used in mechanical area of modular factory building, the side plate comprises an acrylic coating layer, a dual-layer fireproof gypsum board, light steel studs, a dual-layer fireproof gypsum board and an acrylic coating layer, arranged in that order. The dual-layer fireproof gypsum board prevents the wall board from cracking during transportation.

Further, when the partition wall panel were used in clean room of modular factory building, the side plate may include an epoxy coating layer, a dual-layer moisture proof gypsum board, light steel studs, a dual-layer moisture proof gypsum board and an epoxy coating layer, arranged in that order. The epoxy coating layer is suitable for use as an interior wall of the cleaning room. When a partition wall panel were used in clean room of modular factory building, the side plate may include a CPVC cleaning room wall board, a dual-layer moisture proof gypsum board, light steel studs, a dual-layer moisture proof gypsum board and a CPVC cleaning room wall board, arranged in that order. The CPVC is suitable for use as an interior wall of the cleaning room. Furthermore, when the partition wall were used in clean room of modular factory building, the side plate may further include a baking-finish clean steel plate with a thickness of 1 mm, a gypsum board with a thickness of 12.5 mm, light steel studs, a gypsum board with a thickness of 12.5 mm and a baking-finish clean steel plate with a thickness of 1 mm, arranged in that order.

In an embodiment, the modular factory building comprises a connection part 20. The frameworks 11 of two adjacent modules 10 are connected by the connection part 20. Specifically, in an embodiment, the connection part 20 includes a connection plate 21 and a fastener 22. The connection plate 21 is arranged between two adjacent frameworks 11. The connection plate 21 is respectively connected with two frameworks 11 by a fastener 22 which may be, but not limited to, a bolt. In an embodiment, considering the manufacturing precision of the module 10, a negative tolerance is adopted during the processing of the connection plate 21. The connection plate 21 is inserted into a slit between adjacent frameworks 11 and is respectively connected with two frameworks 11. In this embodiment, the connection plate 21 is provided between two frameworks 11 so that the machining error can be compensated. Thereby the stability of the connection of the frameworks 11 can be improved.

More specifically, different modules 10 may expand for connection in the vertical direction and the horizontal direction. Different modules 10 may be used in flexible combination according to various requirements, so as to assemble a desired area of the workshop.

In an embodiment, the module 10 further comprises a square air duct connection part 30. The square air ducts 15 in the air duct system of two adjacent modules are connected with the square air duct connection part 30. The square air duct connection part 30 comprises a square connecting duct 31 and an air duct connecting flange 32. The square connecting duct 31 is connected with a corresponding square air duct 15 by the air duct connecting flange 32. Specifically, in order to guarantee the installation accuracy, the length of the square connecting duct 31 may be set according to the on-site measurement. However, in a working situation where the installation distance is less than the length of the square connecting duct 31, the square connecting duct 31 may be cut according to the distance between the two square air ducts 15 to be connected, thereby satisfying the installation requirements of modules 10 in different positions and facilitating the operation of assembling the modules 10. The square connecting duct 31 is connected with a corresponding square air duct 15 through the air duct connecting flange 32 to guarantee the sealing.

In an embodiment, the module further comprises a circular air duct connection part 40. The circular air ducts 16 in the air duct systems of two adjacent modules 10 are connected by the circular air duct connection part 40. The circular air duct connection part 40 comprises a circular connecting duct 41. The circular connecting duct 41 is in insertion connection with a corresponding circular air duct 16. More specifically, in order to guarantee stable and reliable insertion connection between the circular connecting duct 41 and the circular air duct 16, the length of the circular connecting duct 41 is longer than a length required in the actual installation. In the actual installation, the insertion depth of the circular connecting duct 41 may be adjusted according to the distance between the two circular air ducts 16 to be connected. If the on-site installation requires a relatively large length, the insertion depth of the circular connecting duct 41 is relatively small; if the on-site installation requires a relatively short length, the insertion depth of the circular connecting duct 41 is relatively large. It is possible to satisfy the installation requirements of modules 10 in different positions and facilitates the operation for assembling the modules 10 by adjusting the insertion depth of the circular connecting duct 41. Further, in an embodiment, the circular air duct connection part 40 comprises a clamp 42 connected with the circular connecting duct 41. If the distance between the two circular air ducts 16 to be connected is larger than the length of the circular air duct connection part 40, two or more of the circular connecting duct 41 are used in the connection. The two or more of the circular connecting duct 41 are connected by the clamp 42. Furthermore, in an embodiment, for a circular air duct 16 of a small size, the insertion depth of the circular connecting duct 41 into a corresponding small sized circular air duct 16 should be no less than 50 mm.

In an embodiment, the module further comprises a pipe connecting flange 50, through which the pipes 17 in the pipe systems of two adjacent modules 10 are connected. The pipes 17 of two modules 10 are connected by the pipe connecting flange 50 so that the sealing performance is guaranteed. Further, if the distance between two modules 10 is relatively large, a pipe connection side is provided between two pipes 17 to be connected. The pipe connection side is respectively connected with the corresponding pipe 17 by the pipe connecting flange 50 or welding.

In an embodiment, the module further comprises a cable tray connection part 60 of two modules 10 are connected by the cable tray connection part 60. The cable tray connection part 60 includes a tray connection plate 61 and fasteners (not shown). The tray connection plate 61 is connected with a corresponding cable tray 18 by the fasteners. The length of the cable tray connection part 60 may be cut according to the distance between two cable trays 18 to be connected, thereby satisfying the installation requirements of modules 10 in different positions and facilitating the operation of assembling the modules 10. The cable tray connection part 60 is connected with a corresponding cable tray 18 by the fasteners, achieving a stable and reliable connection. More specifically, the locking piece may be, but not limited to, a bolt or a screw.

The afore-described modularized construction method is capable of improving the construction efficiency, reducing the construction period, and saving the construction cost.

The technical features of the afore-described embodiments may be combined randomly. To be concise, the description does not exhaust all possible combination of the technical features of the afore-described embodiments. However, as long as a combination of technical features does not contain contradiction, such a combination should be considered within the scope of the present disclosure.

The afore-described embodiments only express sortie of the embodiments of the present disclosure, and are described in a rather specific and detailed manner. However, the description should not be understood as limiting the scope of the present disclosure. It is appreciated that, without departing from the concept of the present disclosure, those skilled in the art are able to make a range of variation and improvement to the present disclosure which should be contained in the scope of protection of the present disclosure. Therefore, the scope of protection of the present disclosure should be determined by the appended claims.

What is claimed is:

1. A modular factory building, comprising a plurality of modules (10), the module (10) including a framework (11) provided with an apparatus installation area for installing a process equipment (13) and/or a utility equipment (14), an air duct system, a pipe system, and a cable tray system, wherein each of the air duct system, the pipe system and the cable tray system is arranged on the framework (11) and is connected with the process equipment (13) and/or the utility equipment (14).

2. The modular factory building according to claim 1 further comprising a top plate arranged on a top of the framework and a side plate installed on a side of the framework.

3. The modular factory building according to claim 1 further comprising a connection part (20) through which the frameworks (11) of the two adjacent modules (10) are connected.

4. The modular factory building according to claim 3, wherein the connection part (20) includes a fastener (22) and a connection plate (21) arranged between the two adjacent frameworks (11), wherein the connection plate (21) is respectively connected with the two frameworks (11) by the fastener (22).

5. The modular factory building according to claim 4, wherein the fastener (22) is a bolt.

6. The modular factory building according to claim 1, wherein the module (10) further comprises a square air duct connection part (30), through which square air ducts (15) in the air duct systems of the two adjacent modules (10) are connected, wherein the square air duct connection part (30) includes a square connecting duct (31) and an air duct connecting flange (32), and the square connecting duct (31) is respectively connected with the corresponding square air duct (15) by the air duct connecting flange (32).

7. The modular factory building according to claim 1, wherein the module (10) further comprises a circular air duct connection part (40), through which circular air ducts (16) in the air duct systems of the two adjacent modules (10) are connected, wherein the circular air duct connection part (40) includes a circular connecting duct (41) which is in insertion connection with the corresponding circular air duct (16).

8. The modular factory building according to claim 7, wherein the circular air duct connection part (40) further comprises a clamp (42), which is connected with the circular connecting pipe (41).

9. The modular factory building according to claim 1, wherein the module (10) further comprises a pipe conecting flange (50), through which pipes (17) in the pipe systems of the two adjacent modules (10) are connected.

10. The modular factory building according to claim 1, wherein the module (10) further comprises a cable tray connection part (60), through which cable tray (18) in the cable tray systems of the two adjacent modules (10) are connected, wherein the cable tray connection part (60) includes a tray connecting plate (61) and fasteners, and the tray connecting plate (61) is respectively connected with a corresponding one of the cable tray (18) by the fasteners.
